(19) United States
(12) Patent Application Publication
(10) Pub. No.: US 2011/0030874 A1
(43) Pub. Date: Feb. 10, 2011

(54) LOW TEMPERATURE METHOD OF BONDING SUBSTRATES HAVING AT LEAST ONE SURFACE THAT INCLUDES A LAYER OF SU8

(75) Inventor: Leng Kin Lao, Singapore (SG)

Correspondence Address: CONNOLLY BOVE LODGE & HUTZ LLP, 1875 EYE STREET, N.W., SUITE 1100, WASHINGTON, DC, 20006, US

(73) Assignee: AGENCY FOR SCIENCE, TECHNOLOGY AND RESEARCH, Singapore (SG)

(21) Appl. No.: 12/745,131

(22) PCT Filed: Nov. 28, 2007
(86) PCT No.: PCT/SG07/00409

§ 371 Date: Oct. 26, 2010

(51) Int. Cl. B29C 65/14

(52) U.S. Cl. 156/64; 156/273.3

(57) ABSTRACT

A method of bonding at least two substrates, each substrate having at least one surface that includes a layer of SU8, said method comprising soft baking at least a portion of the layer of SU8 of the first and second substrates, exposing at least the portion of the layer of SU8 of the first and second substrates to ultraviolet (UV) radiation to cross-link at least the portion of the layer of SU8 of the second substrate to a suitable degree, post exposure baking at least the portion of the layer of SU8 of the first substrate at a temperature greater than or equal to 20 degree Celsius (° C.) and less than or equal to 50 degree Celsius (° C.) to cross-link at least the portion of the layer of SU8 of the first substrate to a suitable degree. The method also includes compressing the portion of the cross-linked layer of SU8 of the first substrate against the portion of the cross-linked layer of SU8 of the second substrate at a suitable starting temperature (Tₛ) for a suitable time period (t_{comp}). In addition, the method also includes elevating the temperature during compression from Tₛ to a suitable elevated temperature (Tₑ), thereby bonding the first and second substrates.

The present invention relates to the field of methods of bonding epoxy resin structures together, and more specifically, to a method of bonding at least two substrates, each substrate having at least one surface that includes a layer of SU8.

With an increasing demand for rapid and portable chemical and biological analysis devices and micro sensors, micro total analysis systems (μTAS), which are collectively known as micro systems, are expected to play a key role in the future. Micro systems involved in the analysis of chemical and/or biological samples generally include reservoirs, fluidic channels, filters, reaction chambers, separators, sensors and detectors arranged within silicon or polymer substrates, in addition to embedded integrated circuits (ICs) and sensors, for example. In fabricating a micro system that integrates various parts, such as micro fluidic channels and reservoirs, silicon-based surface micro machining techniques are typically used in order to preserve the functionality of the ICs and sensors, which are embedded (via pre-fabrication) into the micro system. However, the use of silicon-based surface micro machining imposes a limiting constraint on the fabrication of micro systems in that there is, inherently, a limit on the depth and process compatibility at which features, such as channels, reaction chambers and reservoirs can be fabricated.

One well-known technique for overcoming the above limitation is to fabricate micro systems using SU8 material. SU8 is a commercially available, FDA-approved bio-compatible epoxy-based spin-on material that can be photo patterned. SU8 is compatible with ICs and micro electromechanical systems (MEMS), and has material properties that permit the building of micro structures from several microns to millimetres in dimension. Moreover, the hydrophilic, magnetic and fluorescent properties of SU8 can be easily modified in comparison to other commercially available materials that can also be photo-patterned, such as benzocyclobutene (BCB), polymethyl methacrylate (PMMA) and polyimide, for example.

From the microchem website, SU8 is most commonly processed with conventional near ultra-violet (UV) (350-400 nm) radiation, although it may be imaged with e-beam or x-ray. I-line (365 nm) is recommended. Upon exposure, cross-linking proceeds in two-steps: (1) formation of a strong acid during the exposure process, followed by (2) acid-initiated, thermally driven epoxy cross-linking during the post exposure bake (PEB) step. A normal process is: spin coat, soft bake, expose, post expose bake (PEB) and develop. A controlled hard bake is recommended to further cross-link the imaged SU8 structures when they remain as part of the device.

Currently, the bonding and sealing of SU8 based micro systems is carried out by either (i) the thermal compression of two cross-linked SU8 microstructures at 90° C. or higher, or (ii) the pressing of a SU8 microstructure onto an un-cured SU8 layer for blanket UV-exposure followed by thermal curing thereof.

Examples of the method disclosed in (i) can be found in scientific publications such as “Intermediate wafer level bonding and interface behavior”, Microelectronics Reliability, 45 (2005) 657 by C T Pan et al.; “Integrated microfluidics based on multi-layered Su-8 for mass spectrometry analysis” J. Micromech. Microeng. 14 (2004) 619 by J Carlier et al.; and “Fabrication of Su-8 multilayer microstructures based on successive CMOS compatible adhesive bonding and releasing steps” Lab On a Chip 5 (2005) 545 by M Agirregabiria et al.,. In the aforesaid publications, two SU8 microstructures are bonded together by pressing the microstructures together in a face-to-face orientation using a substrate bonder at temperatures ranging between about 95° C. to about 200° C. The timeframe, for which the aforesaid conditions are applied, varies between 8 minutes to about 20 minutes depending on the temperature used.

Examples of the method disclosed in (ii) can be found in scientific publications “Fabrication of micro nozzles using low-temperature wafer-level bonding with Su-8” J. Micromech Microeng 13 (2003) 732 by Sheng Li et al., “Optical particle detection integrated in a dielectrophoretic lab-on-a-chip” J. Micromech. Microeng. 12 (2002) 7 by L Cui et al. and “Microfluidic systems with on-line UV detection fabricated in photodefinable epoxy” J. Micromech. Microeng. 11 (2001) 263 by Rebecca J Jackman et al., which disclose the bonding of SU8 microstructures to an UV-transparent handle wafer having an un-exposed SU8 layer. The SU8 microstructures and the un-exposed SU8 layer of the handle wafer are placed in a face-to-face orientation and are subsequently pressed together. Following the face-to-face pressing, bonding of the SU8 microstructure with the unexposed layer of SU8 of the wafer handle is initialized by a subsequent blanket exposure of the assembly to ultra-violet (UV) radiation through the transparent handle wafer, followed by thermal curing.

However, the methods of bonding SU8 structures, layers or substrates, as disclosed in the aforesaid publications, are not feasible in cases where temperature-sensitive substrates are used or where biomolecules have been coated or immobilized on substrates with SU-8 structures. This is because biological molecules are temperature sensitive. For example, many proteins denature at about 80° C. and deoxyribonucleic acids (DNA) can only withstand temperatures of up to about 100° C. Moreover, biomolecules usually perish when they come into contact with organic solvents or when subjected to plasma treatment and UV exposure.

Accordingly, there is a need for a method of bonding SU8 structures that can be used with temperature sensitive substrates, which is not hazardous to biomolecules. In addition, such a method should also be capable of being carried out using existing processing infrastructure and be simple and yet cost-effective to implement. In this respect, a method, according to the present invention, of bonding at least two substrates together, each substrate having at least one surface that includes a layer of SU8, overcomes the aforesaid difficulties.

In one embodiment of the invention, the method of bonding at least two substrates, each of which having at least one surface that includes a layer of SU8 includes soft baking at least a portion of the layer of SU8 of the first and second substrates, exposing at least the portion of the layer of SU8 of the first and second substrates to ultraviolet (UV) radiation to cross-link at least the portion of the layer of SU8 of the second substrate to a suitable degree, post exposure baking at least the portion of the layer of SU8 of the first substrate at a temperature greater than or equal to 20 degree Celsius (° C.) and less than or equal to 50 degree Celsius (° C.) to cross-link at least the portion of the layer of SU8 of the first substrate to a suitable degree. The exposure of at least one portion of the layer of SU8 of the first and second substrates to ultraviolet (UV) radiation may be carried out independently (that means in separate steps or in separate chambers). This is followed by compressing the cross-linked portion of the layer of SU8 of the first substrate against the cross-linked portion of the layer of SU8 of the second substrate at a suitable starting temperature (Tₛ) for a suitable time period (t_{comp}) and elevating the temperature during compression from Tₛ to a suitable elevated temperature (Tₑ), thereby bonding the first and second substrates.

In another embodiment of the invention, the method of bonding at least two substrates, each substrate having at least one surface that includes a layer of SU8, includes depositing a layer of un-cured SU8 monomer on the layer of SU8 of the first substrate, soft baking the layer of un-cured SU8 monomer and at least a portion of the layer of SU8 of the second substrate, exposing the layer of un-cured SU8 monomer and at least the portion of the layer of SU8 of the second substrate to ultraviolet (UV) radiation to cross-link at least the portion of the layer of SU8 of the second substrate to a suitable degree, post exposure baking the layer of un-cured SU8 monomer at a temperature greater than or equal to 20 degree Celsius (° C.) and less than or equal to 50 degree Celsius (° C.) to cross-link the layer of un-cured SU8 monomer to a suitable degree to form a layer of partially cross-linked SU8 polymer. This is followed by compressing the layer of partially cross-linked SU8 polymer on the layer of SU8 of the first substrate against the cross-linked portion of the layer of SU8 of the second substrate at a suitable starting temperature (Tₛ) for a suitable time period (t_{comp}) and elevating the temperature during compression from Tₛ to a suitable elevated temperature (Tₑ), thereby bonding the first and second substrates.

In another embodiment of the invention, the method of bonding at least two substrates, each substrate having at least one surface that includes a layer of SU8, includes depositing a layer of partially cross-linked SU8 polymer on the layer of SU8 of the first substrate. Forming the partially cross-linked SU8 polymer includes soft baking a layer of un-cured SU8 monomer, exposing the layer of un-cured SU8 monomer to ultraviolet (UV) radiation, post exposure baking the layer of un-cured SU8 monomer at a temperature greater than or equal to 20 degree Celsius (° C.) and less than or equal to 50 degree Celsius (° C.) to cross-link the layer of un0cured monomer to a suitable degree. The method of bonding further includes soft baking at least a portion of the layer of SU8 of the second substrate, exposing at least the portion of the layer of SU8 of the second substrate to ultraviolet (UV) radiation to cross-link at least the portion of the layer of SU8 of the second substrate to a suitable degree. This is followed by compressing the layer of partially cross-linked SU8 polymer on the layer of SU8 of the first substrate against the cross-linked portion of the layer of SU8 of the second substrate at a suitable starting temperature (Tₛ) for a suitable time period (t_{comp}) and elevating the temperature during compression from Tₛ to a suitable elevated temperature (Tₑ), thereby bonding the first and second substrates.

In this context, it should be noted that cross-linking at least a portion of a layer of SU8 to a suitable degree is synonymous to carrying out a partial cross-linking of said layer of SU8. Illustratively speaking, a layer of SU8 cross-linked to a suitable degree is a partially cross-linked layer of SU8. As such, the terms “partial cross-linking” and “cross-linking to a suitable degree” are to be understood as meaning the same thing and are thus, used interchangeably in the description of the method of the invention that follows.

In one embodiment of the invention, the first substrate may be a major substrate while in another embodiment, the second substrate may be a (handling) wafer, or alternatively, a major substrate as well. In this embodiment where the first substrate is a major substrate and the second substrate is either a handling wafer or also a major substrate, it is to be noted that a major substrate is defined as a substrate that includes components that confer major functionality to a final micro system. Examples of components that confer major functionality include, but are not limited to, sensors, detectors, extractors, reaction chambers, filters, micro arrays, separators, valves, pumps and embedded integrated circuits. As an illustrative example, a major substrate, as defined above, may have the method of bonding of the present invention applied to it and form part of a permanent structure of the final micro system.

A handling wafer is defined as an assisting substrate for the micro systems, which may be a bare substrate, or a substrate without functionality components. For example, the handling wafer may be a cap of a micro channel. The handling wafer may, like the major substrate, may be a permanent structure of the final micro systems or, alternatively, the handling wafer may be detached from the final micro system.

The major substrate and/or handling wafer may be fabricated from any suitable material that is compatible with SU8. Illustrative examples of such materials include, but are not limited to, inorganic glass (PYREX®), semi-conductor materials such as silicon, silicon dioxide (quartz) or gallium—arsenide, printed circuit boards, ceramic oxides such as sapphire, or polymers such as Polycarbonate (PC), Polymethyl methacrylate (PMMA) or Polyethylene terephthalate (PET), for example.

In another embodiment, the method of the invention may further include exposing or treating the cross-linked portion of the layer of SU8 of the second substrate with oxygen plasma before compressing the cross-linked portion of the layer of SU8 of the first substrate or the layer of partially cross-linked SU8 polymer on the layer of SU8 of the first substrate against the partially cross-linked portion of the layer of SU8 of the second substrate. The application of oxygen plasma to the partially cross-linked portion of the layer of SU8 of the second substrate helps to break up bonds and promotes the three dimensional cross bonding of SU8 polymer molecules. Oxygen plasma consists of a mixture of electrons, ions and neutral species in local electrical neutrality. The free electric charges in a plasma cause, in contrast to an ordinary gas, high electrical conductivities that can approach those of metals.

Any suitable plasma generation method may be applied for this purpose. As an illustrative example, plasma may be formed by electric discharges (for an overview see e.g. Boulos, M. I., IEEE Transactions on Plasma Science [1991] 19, 6, 1078-1089). A “thermal” (or “equilibrium”) plasma or a “cold” (or “nonequilibrium”) plasma may for instance be used. The treatment process is conducted in a plasma reactor. Commercially available plasma reactors for carrying out cleaning or etching, such as reactive ion etching (RIE), deep-reactive-ion etching (DRIE), and inductive-coupled-plasma deep-reactive-ion etching (ICP-DRIE) may, for example be used. In addition plasma reactors using microwave, direct-current (DC) or radio-frequency (RF) plasmas, or a combination thereof, can for example be applied as well.

In yet another embodiment, the method may further include arranging a temperature sensitive substrate (which is different from the second substrate) or a biomolecule on the first substrate or on the second substrate. Alternatively, the temperature sensitive substrates and the biomolecule may also be applied to the layer of SU8 of the first substrate or on the second substrate as well. This step of including temperature sensitive substrates and/or a biomolecule is typically carried out prior to the compression of the first substrate against the second substrate. Including a temperature sensitive substrate and a biomolecule permits any micro system formed by said first substrate to function as a tool for carrying out chemical and/or biological sample processing. A biomolecule that may be applied to the first substrate include, but are not limited to, a nucleic acid, an oligonucletide, a peptide, a peptoid, a protein, an oligosaccharide, a polysaccharide, a lipid, a virus particle, an entire microorganism such as a cell. A respective biomolecule may have amino, hydroxyl or thiol functional groups, for example, that are immobilized on the surface of the substrate.

The term “nucleic acid molecule” as used herein refers to any nucleic acid in any possible configuration, such as a single stranded nucleic acid, double stranded nucleic acid or a combination thereof. Nucleic acids include for instance DNA molecules (e.g. cDNA or genomic DNA), RNA molecules (e.g. mRNA), analogues of the DNA or RNA generated using nucleotide analogues or using nucleic acid chemistry, locked nucleic acid molecules (LNA), and protein nucleic acids molecules (PNA). DNA or RNA may be of genomic or synthetic origin and may be single or double stranded. In the present method of the invention typically, but not necessarily, an RNA or a DNA molecule will be used. Such nucleic acid can be e.g. mRNA, cRNA, synthetic RNA, genomic DNA, cDNA synthetic DNA, a copolymer of DNA and RNA, oligonucleotides, etc. A respective nucleic acid may furthermore contain non-natural nucleotide analogues and/or be linked to an affinity tag or a label. In some embodiments the nucleic acid molecule may be isolated, enriched, or purified. The nucleic acid molecule may for instance be isolated from a natural source by cDNA cloning or by subtractive hybridization. The natural source may be mammalian, such as human, blood, semen, or tissue. The nucleic acid may also be synthesized, e.g. by the triester method or by using an automated DNA synthesizer.

Many nucleotide analogues are known and can be used in nucleic acids and oligonucleotides used in the methods of the invention. A nucleotide analogue is a nucleotide containing a modification at for instance the base, sugar, or phosphate moieties. Modifications at the base moiety include natural and synthetic modifications of A, C, G, and T/U, different purine or pyrimidine bases, such as uracil-5-yl, hypoxanthin-9-yl, and 2-aminoadenin-9-yl, as well as non-purine or non-pyrimidine nucleotide bases. Other nucleotide analogues serve as universal bases. Universal bases include 3-nitropyrrole and 5-nitroindole. Universal bases are able to form a base pair with any other base. Base modifications often can be combined with for example a sugar modification, such as for instance 2′-O-methoxyethyl, e.g. to achieve unique properties such as increased duplex stability.

A peptide may be of synthetic origin or isolated from a natural source by methods well-known in the art. The natural source may be mammalian, such as human, blood, semen, or tissue. A peptide, including a polypeptide may for instance be synthesized using an automated polypeptide synthesizer. Illustrative examples of polypeptides are an antibody, a fragment thereof and a proteinaceous binding molecule with antibody-like functions. Examples of (recombinant) antibody fragments are Fab fragments, Fv fragments, single-chain Fv fragments (scFv), diabodies or domain antibodies (Holt, L. J., et al., Trends Biotechnol. (2003), 21, 11, 484-490). An example of a proteinaceous binding molecule with antibody-like functions is a mutein based on a polypeptide of the lipocalin family (WO 03/029462, Beste et al., Proc. Natl. Acad. Sci. U.S.A. (1999) 96, 1898-1903). Lipocalins, such as the bilin binding protein, the human neutrophil gelatinase-associated lipocalin, human Apolipoprotein D or glycodelin, posses natural ligand-binding sites that can be modified so that they bind to selected small protein regions known as haptens. Examples of other proteinaceous binding molecules are the so-called glubodies (see e.g. internation patent application WO 96/23879), proteins based on the ankyrin scaffold (Mosavi, L. K., et al., Protein Science (2004) 13, 6, 1435-1448) or crystalline scaffold (e.g. internation patent application WO 01/04144) the proteins described in Skerra, J. Mol. Recognit. (2000) 13, 167-187, and avimers. Avimers contain so called A-domains that occur as strings of multiple domains in several cell surface receptors (Silverman, J., et al., Nature Biotechnology (2005) 23, 1556-1561). Peptoids, which can act as protein ligands, are oligo(N-alkyl) glycines that differ from peptides in that the side chain is connected to the amide nitrogen rather than the α carbon atom. Peptoids are typically resistant to proteases and other modifying enzymes and can have a much higher cell permeability than peptides (see e.g. Kwon, Y.-U., and Kodadek, T., J. Am. Chem. Soc. (2007) 129, 1508-1509).

The surfaces of the first and the second substrates (where the second substrate is also a major substrate), including the SU8 layer, or a part thereof, may also be altered, e.g. by means of a treatment carried out to alter characteristics of a solid surface. Such a treatment may include various means, such as mechanical, thermal, electrical or chemical means. As an illustrative example, the surface properties of any hydrophobic surface can be rendered hydrophilic by coating with a hydrophilic polymer or by treatment with surfactants. Examples of a chemical surface treatment include, but are not limited to exposure to hexamethyldisilazane, trimethylchlorosilane, dimethyldichlorosilane, propyltrichlorosilane, tetraethoxysilane, glycidoxypropyltrimethoxy silane, 3-aminopropyltriethoxysilane, 2-(3,4-epoxy cyclohexyl)ethyltrimethoxysilane, 3-(2,3-epoxy propoxyl)-propyltrimethoxysilane, polydimethylsiloxane (PDMS), γ-(3,4-epoxycyclohexyl)-ethyltrimethoxysilane, poly(methyl methacrylate) or a polymethacrylate co-polymer, urethane, polyurethane, fluoropolyacrylate, poly(methoxy polyethylene glycol methacrylate), poly(dimethyl acrylamide), poly[N-(2-hydroxypropyl)methacrylamide] (PHPMA), α-phosphorylcholine-o-(N,N-diethyldithiocarbamyl)undecyl oligoDMAAm—oligo-STblock co-oligomer (cf. e.g. Matsuda, T., et al., Biomaterials, (2003), 24, 4517-4527), poly(3,4-epoxy-1-butene), 3,4-epoxy-cyclohexyl-methylmethacrylate, 2,2-bis[4-(2,3-epoxy propoxy)phenyl]propane, 3,4-epoxy-cyclohexylmethylacrylate, (3′,4′-epoxycyclohexylmethyl)-3,4-epoxycyclohexylcarboxylate, di-(3,4-epoxycyclohexylmethyl)adipate, bisphenol A (2,2-bis-(p-(2,3-epxoy propoxy)phenyl)propane) or 2,3-epoxy-1-propanol.

The biomolecule (including a plurality thereof) may be immobilised by any means. It may be immobilised on the entire surface or a selected portion of the surfaces of the first and second substrates (where the second substrate is also a major substrate). An illustrative example is the mechanical spotting of the biomolecule onto the surface of the immobilisation unit. This spotting may be carried out manually, e.g. by means of a pipette, or automatically, e.g. by means of a micro robot. Suitable spotting compositions have for example been disclosed in US patent application US 2006/0223074. As an illustrative example, the polypeptide backbone of a biomolecule may be covalently linked to a gold surface via a thio-ether-bond, for example by using ω functionalized thiols. As an illustrative example, amino-terminated nucleic acids may be covalently coupled to an amino-silanated surface via a crosslinker such as 1,4-phenylene diisothiocyanate as described by Manning et al. (Materials Science & Engineering (2003) C3, 347-351).

In some embodiments a biomolecule may be deposited by means of microcontact printing or by inkjet-deposition. As an illustrative example, a monolayer of nucleic acid molecules may be deposited on a selected surface area by inkjet printing of small droplets as described by Bietsch et al. (Langmuir (2004) 20, 5119-5122). In some embodiments a biomolecule may be deposited by dip-pen nanolithography, nanoshaving, nanografting or scanning near-field photolithography (see e.g. Leggett, G. J., Analyst (2005) 130, 259-264). As an illustrative example, a biomolecule can be deposited onto a gold surface by dip-pen nanolithography via a thiol (e.g. 1,9,-nonanedithiol) or a silazane, or onto a SiO₂ surface via a silazane (e.g. divinyltetramethyldisilazane) (see e.g. Pena et al., Langmuir (2003) 19, 9028-9032).

The surfaces of the first and second substrates (where the second substrate is also a major substrate) may be activated prior to immobilising the biomolecule thereon, for instance in order to facilitate the attachment reaction. The surface of the first and second substrate may for example be modified with aminophenyl or aminopropyl silanes. 5′-succinylated nucleic acid molecules may for example be immobilised thereon by carbodiimide-mediated coupling. In some embodiments the surface may for instance be coated with an electroconductive polymer, such as polypyrrole (Wang, J., et al., Anal. Chem. (1999) 71, 18, 4095-4099; Wang, J., et al., Anal. Chim. Acta (1999) 402, 7-12), polythiophene, polyaniline, polyacetylene, poly(N-vinyl carbazole), or a copolymer such as a copolymer of pyrrole and thiophene or a copolymer of juglone and 5-hydroxy-3-thioacetic-1,4-naphtho-quinone (Reisberg, S., et al., Anal. Chem. (2005) 77, 10, 3351-3356). In embodiments where a carbon surface is used, it may for example be modified with carboxyl groups by mixing stearic acid with the paste. A biomolecule may be immobilised on a respective immobilisation unit by means of linking molecule ethylenediamine.

As a further illustrative example, a linking moiety such as an affinity tag may be used to immobilise the biomolecule. Such a linking moiety may be a molecule, e.g. a hydrocarbon-based (including polymeric) molecule that includes nitrogen-, phosphorus-, sulphur-, carbon-, halogen- or pseudohalogen groups, or a portion thereof. As an illustrative example, the selected surface may include, for instance be coated with, a brush-like polymer, for example with short side chains. The immobilisation surface may also include a polymer that includes a brush-like structure, for example by way of grafting. It may for example include functional groups that allow for the covalent attachment of a biomolecule, for example a molecule such as a protein, a nucleic acid molecule, a polysaccharide or any combination thereof. Examples of a respective linking moiety include, but are not limited to, an amino group, an aldehyde group, a thiol group, a carboxy group, an ester, an anhydride, a sulphonate, a sulphonate ester, an imido ester, a silyl halide, an epoxide, an aziridine, a phosphoramidite and a diazoalkane.

A respective affinity tag may be immobilized using any available technique, including the examples above (see e.g. Pena et al., 2003, supra). Examples of an affinity tag include, but are not limited to biotin, dinitrophenol or digoxigenin, oligohistidine, polyhistidine, an immunoglobulin domain, maltose-binding protein, glutathione-S-transferase (GST), calmodulin binding peptide (CBP), FLAG′-peptide, the T7 epitope (Ala-Ser-Met-Thr-Gly-Gly-Gln-Gln-Met-Gly), maltose binding protein (MBP), the HSV epitope of the sequence Gln-Pro-Glu-Leu-Ala-Pro-Glu-Asp-Pro-Glu-Asp of herpes simplex virus glycoprotein D, the hemagglutinin (HA) epitope of the sequence Tyr-Pro-Tyr-Asp-Val-Pro-Asp-Tyr-Ala, the “myc” epitope of the transcription factor c-myc of the sequence Glu-Gln-Lys-Leu-Ile-Ser-Glu-Glu-Asp-Leu, or an oligonucleotide tag. Such an oligonucleotide tag may for instance be used to hybridise to an immobilised oligonucleotide with a complementary sequence. A further example of a linking moiety is an antibody, a fragment thereof or a proteinaceous binding molecule with antibody-like functions (see also above).

A further example of an affinity tag is a cucurbituril or a moiety capable of forming a complex with a cucurbituril. A cucurbituril is a macrocyclic compound that includes glycoluril units, typically self-assembled from an acidcatalyzed condensation reaction of glycoluril and formaldehyde. A cucurbit[n]uril, (CB[n]), that includes n glycoluril units, typically has two portals with polar ureido carbonyl groups. Via these ureido carbonyl groups cucurbiturils can bind ions and molecules of interest. As an illustrative example cucurbit[7]uril (CB[7]) can form a strong complex with ferrocenemethylammonium or adamantylammonium ions. It has for instance been shown that a biomolecule such as e.g. a protein carrying a ferrocenemethylammonium unit (or a plurality thereof) can be immobilised on a gold surface via alkanethiolates on the gold surface, which carry functionalised CB[7] units (Hwang, I, J. Am. Chem. Soc (2007) 129, 4170-4171).

Further examples of a linking moiety include, but are not limited to an oligosaccharide, an oligopeptide, biotin, dinitrophenol, digoxigenin and a metal chelator (cf. also below). As an illustrative example, a respective metal chelator, such as ethylenediamine, ethylenediaminetetraacetic acid (EDTA), ethylene glycol tetraacetic acid (EGTA), diethylenetriaminepentaacetic acid (DTPA), N,N-bis(carboxymethyl)glycine (also called nitrilotriacetic acid, NTA), 1,2-bis(o-aminophenoxy)ethane-N,N,N′,N′-tetraacetic acid (BAPTA), 2,3-dimercapto-1-propanol(dimercaprol), porphine or heme may be used in cases where the target molecule is a metal ion. As an example, EDTA forms a complex with most monovalent, divalent, trivalent and tetravalent metal ions, such as e.g. silver (Ag⁺), calcium (Ca²⁺), manganese (Mn²⁺), copper (Cu²⁺), iron (Fe²⁺), cobalt (Co³⁺) and zirconium (Zr⁴⁺), while BAPTA is specific for Ca²⁺. In some embodiments a respective metal chelator in a complex with a respective metal ion or metal ions defines the linking moiety. Such a complex is for example a receptor molecule for a peptide of a defined sequence, which may also be included in a protein. As an illustrative example, a standard method used in the art is the formation of a complex between an oligohistidine tag and copper (Cu²⁺), nickel (Ni²⁺), cobalt (Co²⁺), or zink (Zn²⁺) ions, which are presented by means of the chelator nitrilotriacetic acid (NTA).

Avidin or streptavidin may for instance be employed to immobilise a biotinylated nucleic acid, or a biotin containing monolayer of gold may be employed (Shumaker-Parry, J. S., et al., Anal. Chem. (2004) 76, 918). As yet another illustrative example, the biomolecule may be locally deposited, e.g. by scanning electrochemical microscopy, for instance via pyrrole-oligonucleotide patterns (e.g. Fortin, E., et al., Electroanalysis (2005) 17, 495). In other embodiments, in particular where the biomolecule is a nucleic acid, the biomolecule may be directly synthesised on the surface of the immobilisation unit, for example using photoactivation and deactivation. As an illustrative example, the synthesis of nucleic acids or oligonucleotides on selected surface areas (so called “solid phase” synthesis) may be carried out using electrochemical reactions using electrodes. An electrochemical deblocking step as described by Egeland & Southern (Nucleic Acids Research (2005) 33, 14, e125) may for instance be employed for this purpose. A suitable electrochemical synthesis has also been disclosed in US patent application US 2006/0275927. In some embodiments light-directed synthesis of a biomolecule, in particular of a nucleic acid molecule, including UV-linking or light dependent 5′-deprotection, may be carried out.

As a further illustrative example, a mixture of a polyelectrolyte such as poly(3-8(S)-5-amino-5-methoxycarboxyl-3-oxapentyl]2,5-thiophenylene hydrochloride) and a peptide (e.g. a synthetic peptide or a peptide isolated from natural sources) or a mixture of poly(3-[(S)-5-amino-5-carboxyl-3-oxapentyl]-2,5-thiophenylene hydrochloride) and calmodulin may be immobilised on a surface area of poly(dimethylsiloxane) by incubation of a respective buffered aqueous solution thereon and subsequently drying the same as described by Åsberg et al. (Langmuir (2006) 22, 5, 2205-2211).

Reverting back to the bonding method of the invention, in one exemplary embodiment, cross-linking of at least the portion of the layer of SU8 of the first substrate to a suitable degree includes exposing said portion of the layer of SU8 of the first substrate to UV radiation followed by subjecting the portion to a suitable cross-linking temperature (T_{pc}) for a suitable period of time (t_{pc}). In another embodiment, cross-linking the layer of un-cured monomer on the layer of SU8 of the first substrate to a suitable degree includes exposing the later of un-cured monomer on the layer of SU8 of the first substrate to UV radiation followed by subjecting the layer of un-cured monomer to a suitable cross-linking temperature (T_{pc}) for a suitable period of time (t_{pc}). In carrying out the cross-linking of at least a portion of the layer of SU8 of the first substrate or the layer of un-cured monomer on the layer of SU8 of the first substrate to a suitable degree (i.e. carrying out a partial cross-linking of said layer of SU8), T_{pc} may be taken to be a temperature that ranges between about room temperature to about 50 degree Celsius (° C.) and t_{pc} may vary from one week to between about thirty to about sixty minutes, for example. In the case where T_{pc} is room temperature T_{pc} may range between about 20 degree Celsius (° C.) to about 25 degree Celsius (° C.), for example. Correspondingly, the t_{pc} may range from about 30 minutes to about several days. For example the cross-linking may require between about four to six days (i.e. about one week). Alternatively, where T_{pc} is about 50° C., the corresponding t_{pc} may be between about thirty to about sixty minutes. In any case, the person skilled in the art may easily determine by experimentation a suitable T_{pc} and corresponding t_{pc} as may be required.

In one exemplary embodiment, cross-linking of at least a portion of the layer of SU8 of the second substrate to a suitable degree includes exposing said portion of the layer of SU8 of the second substrate to UV radiation optionally follow by subjecting the same portion to a suitable cross-linking temperature (T_{pc}) for a suitable period of time (t_{pc}). In carrying out the partial cross-linking of at least a portion of the layer of SU8 of the second substrate, T_{pc} may be taken to be a temperature that ranges between about room temperature to about 50 degree Celsius (° C.) and t_{pc} may vary from one week to between about one minute, for example. In the case where T_{pc} is room temperature, the t_{pc} may be from one minute to between about several days, for example it may require between about four to six days (i.e. about one week). Alternatively, where T_{pc} is about 50° C., the corresponding t_{pc} may be between about one to about sixty minutes. In any case, the person skilled in the art may easily determine by experimentation a suitable T_{pc} and corresponding t_{pc} as may be required.

In another exemplary embodiment, during the step of compressing the cross-linked portion of the layer of SU8 of the first substrate or the layer of partially cross-linked SU8 polymer on the layer of SU8 of the first substrate against the cross-linked portion of the layer of SU8 of the second substrate, the temperature at which the compression starts (which temperature is denoted by Tₛ) may be lower than or equal to T_{pc}. In this exemplary embodiment, t_{comp}, is the time period for which compression at Tₛ is carried out, and may vary between about thirty to about sixty minutes, for example.

In one embodiment, when elevation of the temperature from Tₛ to Tₑ occurs during compression, it is to be noted that Tₑ is still maintained at a temperature of less than or equal to about 90 degree Celsius (° C.). This elevation of temperature may be carried out linearly, exponentially, step-wise or in any combination thereof. The time period for which compression is carried out at elevated temperature Tₑ depends largely upon the magnitude of Tₑ. In other words, generally, it may be taken that the time period t_{comp} during which compression is carried out is inversely related to the temperatures (Tₛ and Tₑ) at which said compression is carried out. Accordingly, the higher Tₛ and Tₑ are (but below 90° C.), the shorter the period t_{comp} will be.

It is to be noted that in one exemplary embodiment, the starting temperature Tₛ may be about room temperature, which may be between about 20 degree Celsius (° C.) to about 25 degree Celsius (° C.), for example. Alternatively, Tₛ may be at about 50 degree Celsius (° C.). Also to be noted is that the period t_{comp} may vary between about thirty minutes to about twenty-four to about forty-eight hours in duration.

When carrying out the partial cross-linking of the at least a portion of the layer of SU8 of the first substrate or the layer of un-cured monomer on the layer of SU8 of the first substrate to a suitable degree, the suitable degree of cross-linking of the portion of the layer of SU8 of the first substrate or the layer of un-cured monomer on the layer of SU8 of the first substrate may be ascertained by dissolving said partially cross-linked portion of the layer of SU8 or the layer of partially cross-linked SU8 of the first substrate in acetone. Alternatively, the suitable degree of cross-linking of the portion of the layer of SU8 of the first substrate or the layer of un-cured monomer on the layer of SU8 of the first substrate may be ascertained when said partially cross-linked portion of the layer of SU8 or the layer of partially cross-linked SU8 of the first substrate remains undissolved in isopropanol (IPA). As for the second substrate, the suitable degree of cross-linking of the portion of the layer of SU8 of the second substrate may be ascertained by dissolving said partially cross-linked portion of the layer of SU8 in acetone.

A summary of the method to generate the partially cross-linking portions of the first and second substrates of the present invention is presented in the table below:

| | Process | | | | | | |
|---|---|---|---|---|---|---|---|
| | | | Post Exposure | Post Exposure | | | |
| Sub- | | UV | Bake/Curing | Bake/Curing | | Acetone | |
| strate | Soft Bake | exposure | after UV exposure | temperature | Curing time | test | IPA test |
| 1^{st} | Necessary | Necessary | Necessary | Room temp to 50 | 30 mins to | Applicable | Applicable |
| | | | | degree C. | 1 week | | |
| 2^{nd} | Necessary | Necessary | Optional | Room temp to 50 | 1 min to 1 | Applicable | Not to be used |
| | | | | degree C. | week | | |

Various aspects of the present invention will now be described with reference to the following illustrated exemplary embodiments of the present invention in which:

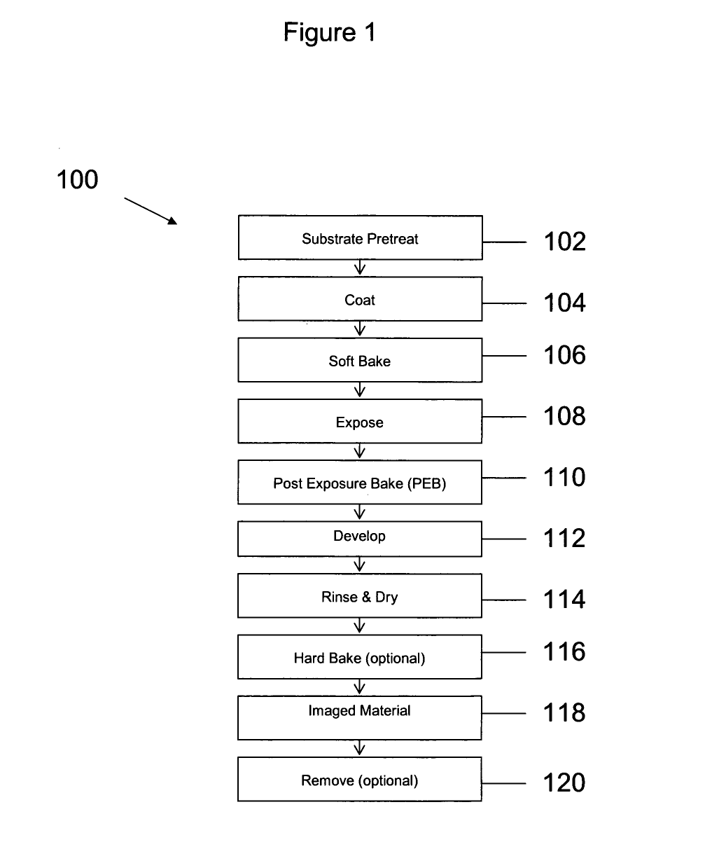

FIG. 1 is a prior art process flow diagram that illustrates conventional steps of processing SU8;

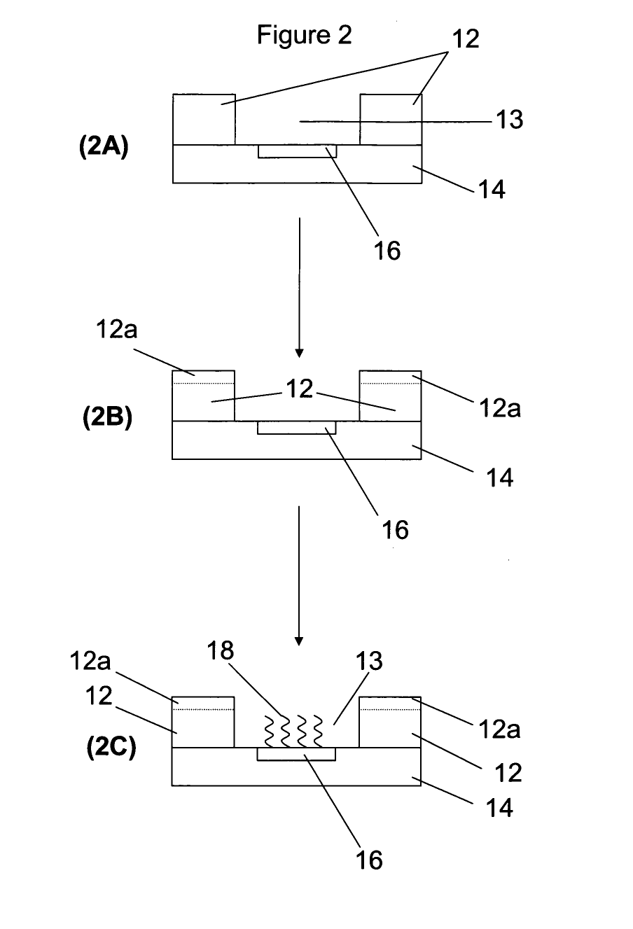

FIG. 2 is a process flow diagram that illustrates steps of processing a first substrate;

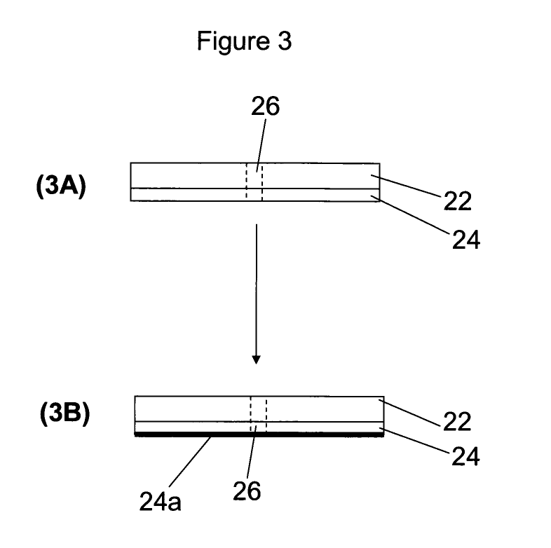

FIG. 3 is a process flow diagram that illustrates steps of processing a second substrate;

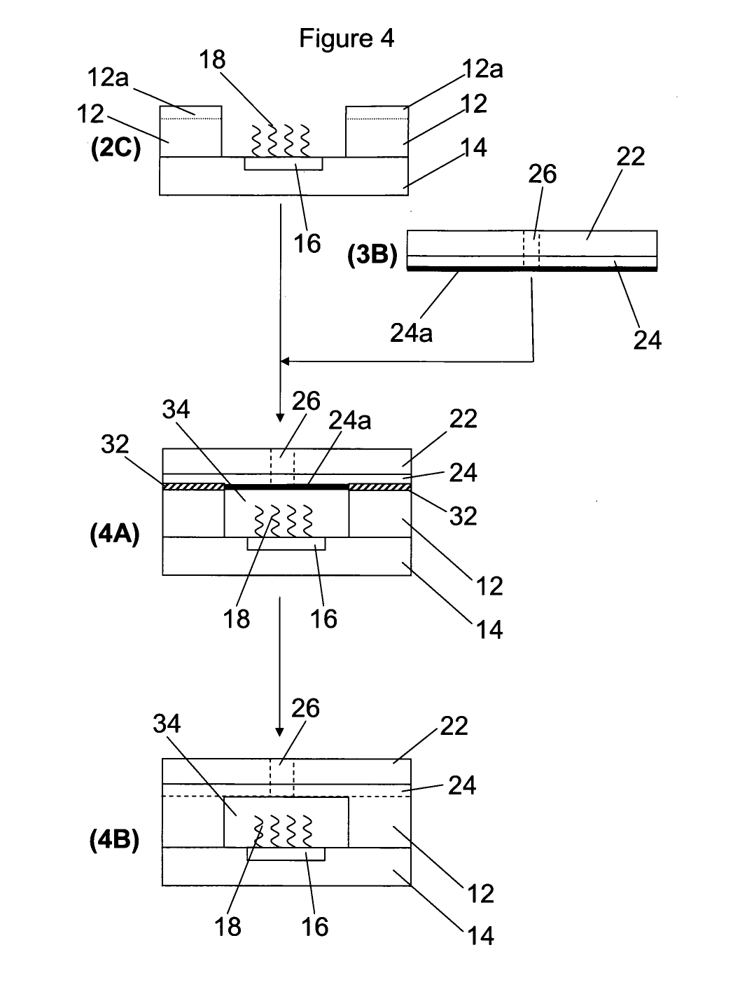

FIG. 4 is a process flow diagram that illustrates steps of bonding a first substrate of FIG. 2 to a second substrate of FIG. 3;

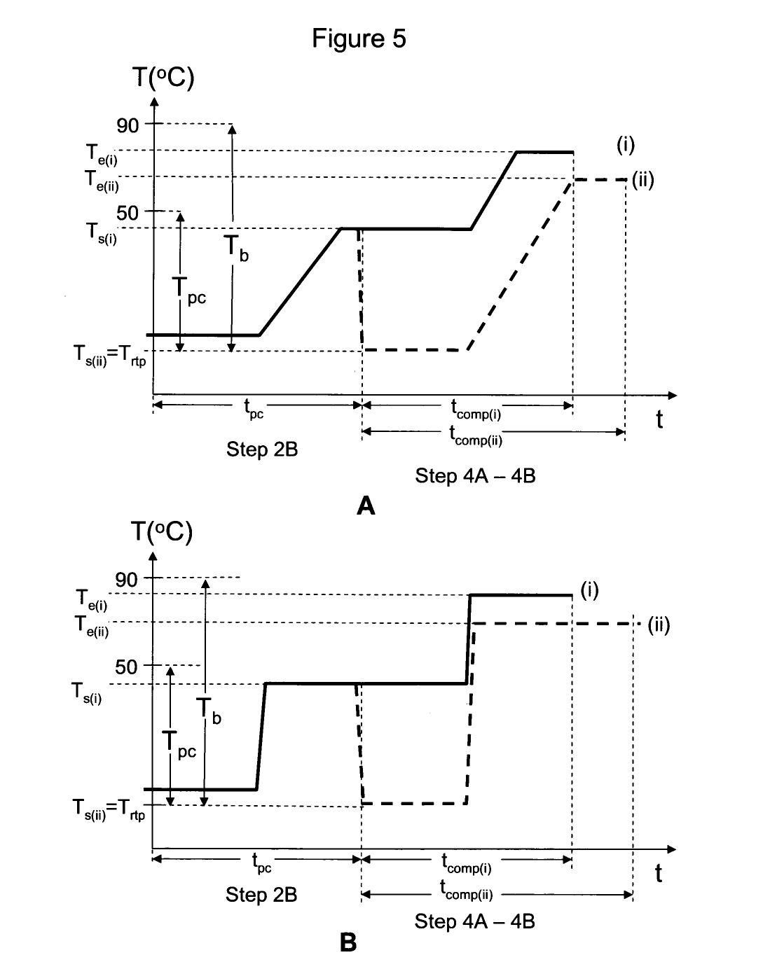

FIGS. 5A and 5B are graphs that illustrate the variation of processing temperature against time for the periods t_{pc} and t_{comp};

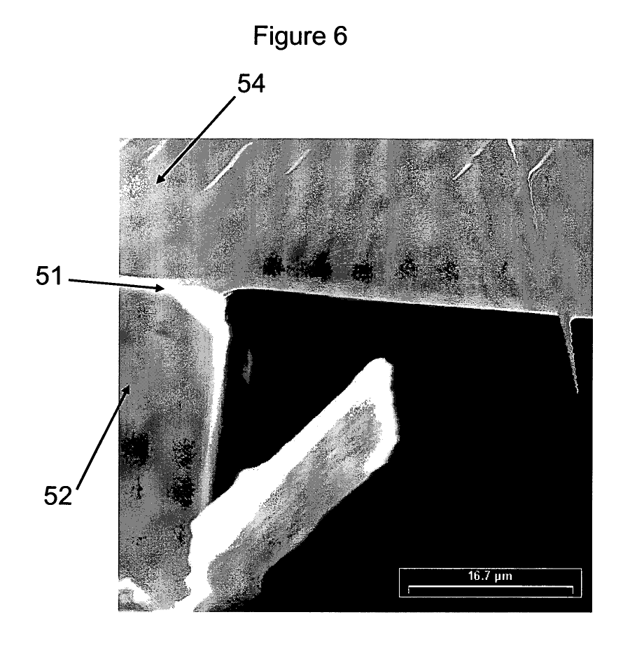

FIG. 6 is a cross-sectional scanning electron microscope (SEM) image of the bonding interface between a first substrate and a second substrate; and

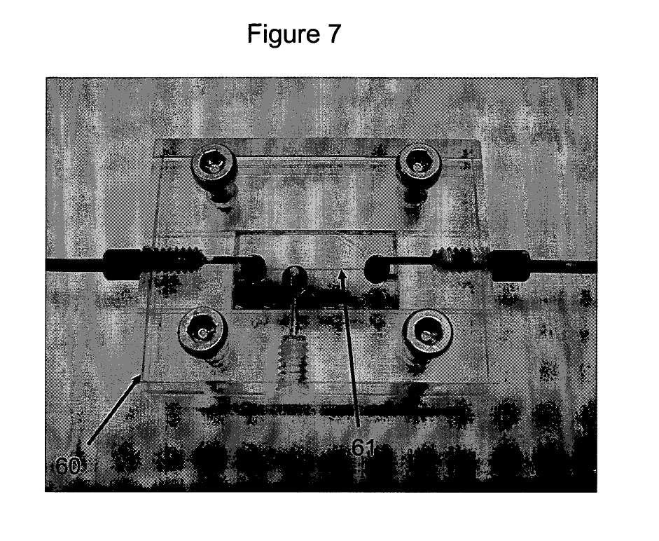

FIG. 7 is a picture of an encapsulated device formed by bonding of a first and second substrate, each having a layer of SU8, according to the methods of the present invention.

FIG. 1 is a prior art process flow diagram 100 that illustrates steps of processing SU8. Starting with step 102, the base substrate is pre-treated. To obtain maximum process reliability, substrates should be clean and dry prior to applying the SU8 resist. The substrates are cleaned by a solvent cleaning, or by rinsing with dilute acid, followed by a de-ionized (DI) water rinse. Where applicable, substrates should be subjected to a piranha etch or clean. To dehydrate the surface, the substrates are baked at about 200° C. for about 5 minutes on a hotplate. Next in step 104, the substrate is coated with the SU8 resist. After the SU8 resist has been applied onto the substrate, it must be soft baked to evaporate the solvent and intensify the film as indicated in step 106. In step 108, SU8 is optimized for near UV (350 nm to 400 nm) exposure. I-line exposure tools can be used. SU8 is virtually transparent and insensitive above 400 nm but has high actinic absorption below 350 nm. Excessive dose below 350 nm may, therefore, result in over exposure of the top portion of the resist film, resulting in exaggerated negative sidewall profiles or T-topping. The optimal exposure dose will depend on film thickness (thicker films require higher dosage) and process parameters. Following exposure, a post expose bake (PEB) must be performed to selectively cross-link the exposed portions of the film as indicated in step 110. This post exposure bake can be performed either on a hot plate or in a convection oven. The post-exposure bake temperature is above 65 degree Celsius (° C.), for example between 90 degree Celsius (° C.) to 200 degree Celsius (° C.). In step 112, SU8 resist is developed. Immersion, spray or spray-puddle processes can be used. Other solvent based developers such as ethyl lactate and diacetone alcohol may also be used. Strong agitation is used for high aspect ratio and/or thick film structures. Following development, in step 114, the substrate is rinsed briefly with isopropyl alcohol (IPA), then dried with a gentle stream of air or nitrogen. In step 116, hard bake or cure may be performed. This is an optional step. SU8 has good mechanical properties, therefore hard bakes are normally not required. For applications where the imaged resist is to be left as part of the final device, the resist may be ramp/step hard baked between 150-200° C. on a hot plate or in a convection oven to further cross link the material as in step 118. Bake times vary based on type of bake process and film thickness. Finally in step 120, SU8 is removed and this is an optional step.

The current invention differs from the prior art process flow in that the post exposure bake is performed at between a temperature greater than or equal to room temperature, about 20 degree Celsius (° C.) to 25 degree Celsius (° C.) and less than or equal to 50 degree C., for example.

FIGS. 2A-2C depict steps of a process flow diagram that illustrates pre-bonding processing of a first substrate 14. In step 2A, the substrate 14 has at least a layer of SU8 12 thereon. Also on the substrate 14 is a biomolecular compatible surface 16 upon which a biomolecule may be attached to. The layer of SU8 12 is, when viewed from a sectional view, essentially two structures of similar height that, in combination with the substrate 14, form an open channel 13. The biomolecular compatible surface 16 is shown to be generally centrally located at the bottom of the open channel 13. Alternatively, the biomolecular compatible surface 16 may also be located along the parallel SU8 walls 12, for example.

In step 2B, a top portion of SU8 12a of the layer of SU8 12 is cross-linked to a suitable degree, i.e. partially cross-linked. This partial cross-linking of the top portion 12a of the layer of SU8 12 may be achieved, in one exemplary embodiment of the invention, by first partially cross-linking SU8 followed by the deposition and patterning of said partially cross-linked SU8 onto the layer of SU8 12 of the substrate 14. In this exemplary embodiment, the partial cross-linking of the SU8 prior to deposition and patterning thereof to form top portion 12a of the layer of SU8 12 may be achieved by first exposing SU8 to ultra-violet (UV) radiation followed by a baking step, which may also be referred to as a curing step, at a temperature greater than or equal to 20 degree Celsius (° C.) and less than or equal to 50 degree C., for example.

The duration of the exposure to UV radiation is typically related to the UV radiation intensity of the equipment used. As such, a more accurate measure of the exposure to UV radiation may be done in terms of the exposure energy dose. The exposure energy dose typically depends on the thickness of the layer 12a and can be determined experimentally. For example, where the top portion 12a is 6 μm thick, the exposure energy dose is 150 mJ/cm².

Once the SU8 to be deposited onto the layer of SU8 12 of the first substrate 14 has been partially cross-linked (via UV exposure followed by the baking step, as described above), the degree (or extent) of cross-linking may be tested by adding acetone to a sample of the partially cross-linked SU8. In this test, the partially cross-linked SU8 should dissolve in the acetone after a period of time to indicate that said SU8 has achieved a suitable level of cross-linking. Another test of whether a suitable degree of cross-linking has been achieved may be by carried out by attempting to dissolve a sample of the SU8 in isopropanol (IPA). In the test involving IPA, the SU8, if sufficiently cross-linked, should not dissolve in the IPA nor should it turn white in colour after an IPA rinse. Following the partial cross-linking of the SU8, and determination of the extent of said partial cross-linking, the suitably partially cross-linked SU8 may then be deposited and patterned onto the layer of SU8 12 of the first substrate 14 to form partially cross-linked layer 12a as shown in steps 2B and 2C of FIG. 2.

Another way of forming the top portion 12a of the layer of SU8 12 is by first depositing a layer of an un-cured SU8 monomer onto the SU8 layer 12, followed by the patterning and partial cross-linking of the deposited SU8 monomer to a suitable degree. This results in the formation of the cross-linked top portion 12a of SU8 on the SU8 layer 12. The cross-linking of the top portion 12a may be carried out by any of the above-mentioned methods, i.e. via UV exposure, follow by a baking step, as described above.

Yet another alternative way of forming the top portion 12a of the layer of SU8 12 is by subjecting the SU8 layer 12 itself to cross-linking to a suitable degree during the fabrication process using any of the above methods (i.e. UV exposure, follow by the baking step, for example) in order to obtain a partially cross-linked SU8 top portion 12a.

In step 2C, a biomolecule 18 may be included onto the biomolecular compatible surface 16 on the substrate 14 such that said biomolecule 18 is within the open channel 13. It is to be noted that the addition of the biomolecule 18 should be carried out after the deposition or formation of the partial cross-linked SU8 top portion 12a on the layer of SU8 12. This is because the biomolecule 18, if deposited on the biomolecular compatible surface 16 prior to said cross-linking, may be susceptible to damage from the cross-linking process, thus rendering it ineffective later on.

FIG. 3 is a process flow diagram that illustrates a pre-bonding processing of a second substrate 22. The pre-bonding processing of the second substrate 22 can be done independently (in a separate processing chamber or at a separate time) from the pre-bonding processing of the first substrate 14. The second substrate 22 is illustrated as being a planar substrate (handling wafer) having a planar layer of SU8 24 thereon. In this embodiment, the second substrate 22 also includes a through-hole 26 that extends through both the second substrate 22 and the layer of SU8 24. The through-hole 26 may be utilized later on for the inclusion of reagents, reactants or for the extraction of samples during microfluidics processing, for example. As described above, the second substrate 22 is not limited to being a handling wafer. Alternatively, the second substrate 22 may be a major substrate, similar to that as described earlier in relation to the first substrate 14.

In the process step 3A, a partial cross-linking step, the SU8 layer 24 is exposed to UV radiation, optionally followed by post exposure baking at a temperature of equal to or less than 50 degree Celsius (° C.). This partial cross-linking of the layer of SU8 24 may be achieved, in one exemplary embodiment of the invention, by first partially cross-linking SU8 (as described above) followed by the deposition and patterning of said partially cross-linked SU8 onto the substrate 22.

Once the SU8 to be deposited onto the layer of SU8 24 of the substrate 22 has been partially cross-linked (via UV exposure optionally follow by post exposure baking, as described above), the degree (or extent) of cross-linking may be tested by adding acetone to a sample of the partially cross-linked SU8. In this test, the partially cross-linked SU8 should dissolve in the acetone after a period of time to indicate that said SU8 has achieved a suitable level of cross-linking. Following the partial cross-linking of the SU8, and determination of the extent of said partial cross-linking, the remaining suitably partially cross-linked SU8 may then be deposited and patterned onto the second substrate 22 to form partially cross-linked layer 24 as shown in step 3A of FIG. 3.

Another way of forming the layer of SU8 24 is by first depositing a layer of an un-cured SU8 monomer onto the second substrate 22, follow by the patterning and partial cross-linking of the deposited SU8 monomer to a suitable degree. This results in the formation of the partially cross-linked SU8 layer 24. The cross-linking of the layer 24 may be carried out by any of the above-mentioned methods, i.e. via UV exposure, optionally follow by baking, for example.

In one embodiment, in an optional process step 3B, the SU8 layer 24 of the second substrate 22 may also be exposed to oxygen plasma to create an oxygen plasma treated surface 24a on the layer of SU8 24. As mentioned earlier, the application of oxygen plasma to the UV radiated portion of the layer of SU8 of the second substrate after partial cross-linking helps to promote the three dimensional cross bonding of SU8 polymer molecules. In this embodiment, the second substrate 22 is a handling wafer. In another embodiment, the second substrate is a major substrate, and the above-mentioned optional oxygen plasma treatment is applicable only when there is no plasma-sensitive substrate or biomolecule immobilized or coated on the second substrate 22.

FIG. 4 is a process flow diagram that illustrates the bonding steps 4A and 4B of the first substrate 14 to the second substrate 22. Each substrate, 14 and 22, has been previously processed, as described above, according to the flow diagrams of FIGS. 2 and 3, respectively. Accordingly, prior to process step 4A, formation/modification of the first substrate 14 is the result of process steps 2A-2C and formation/modification of the second substrate 22 is the result of either one of process steps 3A and/or 3B, since step 3B, as mentioned above, is optional. In this embodiment of the process flow diagram, the second substrate is taken to have undergone processing step 3B as well.

In step 4A, the first and second substrates 14 and 22 are aligned such that their respective “activated” SU8 layers (referring to the partially cross-linked SU8 top portion 12a of the first substrate 14, and the partially cross-linked and oxygen plasma treated SU8 surface 24a of the second substrate 22) are arranged in a face to face orientation with respect to each other. The two substrates 14 and 22 are then pressed together at room temperature (Tᵣₜₚ), for example. Alternatively, a higher starting temperature (Tₛ) not exceeding 50° C. may also be used. A thermal compression machine or wafer bonder may be used to carry out the compression of the first substrate 14 against the second substrate 22 for a suitable period of time, t_{comp}, for example.

During the compression step 4A, the orientation of the first substrate 14 with respect to the second substrate 22 results in the open channel 13 to become a closed channel 34. The closed channel 34 is bounded on either side and below by parallel SU8 walls 12, and the first substrate 14, respectively. The top of the channel 34 is bounded by the activated SU8 layer 24a of the second substrate 22. Interface 32, between the partially cross-linked SU8 layer 12a and the oxygen plasma activated SU8 layer 24a is known as the bonding interface.

Following step 4A, in step 4B, the temperature of the bonding interface 32 is increased (but not exceeding 90° C.) while the compression of the two substrates 14 and 22 is maintained. The increase or elevation in temperature from Tₛ to elevated temperature Tₑ may be linear, step-wise or exponential, for example. Further details of the temperature variation during the cross-linking and bonding steps are described with reference to FIG. 5 below.

FIGS. 5A and 5B are graphs that illustrate the variation of processing temperature against time. Referring to both FIGS. 5A and 5B, the term T_{pc} denotes the temperature range between which partial cross-linking may be carried out. The partial cross-linking temperature ranges between about room temperature (Tᵣₜₚ) to about 50° C. The cross-linking temperature is only applied over the period when cross-linking takes place, i.e. over step 2B, which is denoted by t_{pc}.

Again with reference to both FIGS. 5A and 5B, the term T_{b} denotes the temperature range over which bonding between the top portion 12a of the layer of SU8 12 of the first substrate 14 and the partially cross-linked layer of SU8 24a of the second substrate 22 takes place when said substrates 12 and 22 are pressed against each other. As mentioned earlier, this bonding process takes place during steps 4A-4B between the range of about Tᵣₜₚ to about 90° C. The terms t_{comp(i)} and t_{comp(ii)} denote alternative pathways that the process may follow during the steps 4A-4B when carrying out the method of the present invention.

Turning to FIG. 5A, the temperature applied to the SU8 that forms the top portion 12a of the layer of SU8 12 of the first substrate 14, and layer of SU8 24 of the second substrate is indicated to lie within the above specified range of T_{pc}, i.e. between Tᵣₜₚ and about 50° C. In FIG. 5A, the temperature applied during cross-linking is constant and slightly above Tᵣₜₚ at the beginning, and is increased linearly up to just below 50° C. towards the end of the period t_{pc}. Alternatively, the temperature applied during cross-linking may be constant over the time period t_{pc}, increasing linearly, exponentially or any combination thereof, provided it does not exceed about 50° C.

At the end of the period t_{pc}, the steps 4A-4B follow. During the step 4A, which is the bonding step of the two substrates 14 and 22, the bonding temperature T_{b} may be the same temperature as that which was applied at the end of the period t_{pc}. In this respect, the temperature may be continuously applied as shown over the period t_{comp(i)}. The bonding temperature T_{b} is initially at Tₛ₍ᵢ₎ and is applied as a constant along with a uniform compression force on the two substrates 14 and 22. Subsequently, the temperature is elevated linearly to Tₑ₍ᵢ₎, and maintained below 90° C.

As an alternative to process path (i), the method of the invention may also follow a process path (ii) as shown in FIG. 5A. Process path (ii) only differs during steps 4A-4B in the applied bonding temperature T_{b}. In process path (ii), the bonding temperature starts at Tₛ₍ᵢᵢ₎, which is Tᵣₜₚ. As in process path (i), the temperature is also kept constant along with the application of a uniform compression force on the two substrates 14 and 22. Subsequently, the bonding temperature T_{b} rises linearly to Tₑ₍ᵢᵢ₎ and remains there till the end of t_{comp(ii)}. As shown, Tₑ₍ᵢ₎ is greater than Tₑ₍ᵢᵢ₎. As such, the time period for bonding the substrates 14 and 22 when a temperature of Tₑ₍ᵢ₎ is applied is less than the time period when Tₑ₍ᵢᵢ₎ is applied. In other words, the temperature at which compression (bonding) is carried out is inversely related to the time period during which said compression (bonding) is carried out.

Referring to FIG. 5B, the graph of temperature against time is essentially the same as that of FIG. 5A except that the increases in temperature from Tₛ₍ᵢ₎ to Tₑ₍ᵢ₎ or from Tₛ₍ᵢᵢ₎ to Tₑ₍ᵢᵢ₎ are both substantially step-wise instead of linear. In addition, it should be noted that apart from linear or step-wise increases in temperature, the increases in the temperature applied may also be exponential or the temperature may simply be applied at a constant value for the duration of the bonding period t_{comp(i)} or t_{comp(ii)} according to the inverse relationship described above between the temperature at which compression (bonding) is carried out and the time period during which said compression (bonding) is carried out.

FIG. 6 is a cross-sectional scanning electron microscope (SEM) image of the bonding interface 51 between a layer of SU8 52 of a first substrate and a layer of SU8 54 of a second substrate when the method of the present invention is applied between temperatures of 50° C.-90° C. Sharp edges of the microstructures are shown indicating that no SU8 reflow into the closed channel 34 (not shown) has taken place.

FIG. 7 is a top view of an encapsulated device 60 formed by bonding a first and second substrate, each having a layer of SU8, according to the method of the present invention. The reference sign 61 indicates a micro fluidic channel encapsulated within the first and second substrates.

It should be noted that the exemplary embodiments described above merely serve to aid in the understanding of the various aspects of the present invention. Accordingly, said various aspects of the present invention are not to be construed to as being limited to said exemplary embodiments, but rather, as defined by the claims that follow.

1. A method of bonding at least two substrates, each substrate having at least one surface that includes a layer of SU8, said method comprising:
soft baking at least a portion of the layer of SU8 of the first and second substrates;
exposing at least the portion of the layer of SU8 of the first and second substrates to ultraviolet (UV) radiation to cross-link at least the portion of the layer of SU8 of the second substrate to a suitable degree;
post exposure baking at least the portion of the layer of SU8 of the first substrate at a temperature greater than or equal to 20 degree Celsius (° C.) and less than or equal to 50 degree Celsius (° C.) to cross-link at least the portion of the layer of SU8 of the first substrate to a suitable degree;
compressing the cross-linked portion of the layer of SU8 of the first substrate against the cross-linked portion of the layer of SU8 of the second substrate at a suitable starting temperature (Tₛ) for a suitable time period (t_{comp}); and
elevating the temperature during compression from Tₛ to a suitable elevated temperature (Tₑ), thereby bonding the first and second substrates.

2. A method of bonding at least two substrates, each substrate having at least one surface that includes a layer of SU8, said method comprising:
depositing a layer of un-cured SU8 monomer on the layer of SU8 of the first substrate;
soft baking the layer of un-cured SU8 monomer and at least a portion of the layer of SU8 of the second substrate;
exposing the layer of un-cured SU8 monomer and at least the portion of the layer of SU8 of the second substrate to ultraviolet (UV) radiation to cross-link at least the portion of the layer of SU8 of the second substrate to a suitable degree;
post exposure baking the layer of un-cured SU8 monomer at a temperature greater than or equal to 20 degree Celsius (° C.) and less than or equal to 50 degree Celsius (° C.) to cross-link the layer of un-cured SU8 monomer to a suitable degree to form a layer of partially cross-linked SU8 polymer;
compressing the layer of partially cross-linked SU8 polymer on the layer of SU8 of the first substrate against the cross-linked portion of the layer of SU8 of the second substrate at a suitable starting temperature (Tₛ) for a suitable time period (t_{comp}); and
elevating the temperature during compression from Tₛ to a suitable elevated temperature (Tₑ), thereby bonding the first and second substrates.

3. A method of bonding at least two substrates, each substrate having at least one surface that includes a layer of SU8, said method comprising:
depositing a layer of partially cross-linked SU8 polymer on the layer of SU8 of the first substrate; wherein forming the partially cross-linked SU8 polymer includes:
soft baking a layer of un-cured SU8 monomer;
exposing the layer of un-cured SU8 monomer to ultraviolet (UV) radiation;
post exposure baking the layer of un-cured SU8 monomer at a temperature greater than or equal to 20 degree Celsius (° C.) and less than or equal to 50 degree Celsius (° C.) to cross-link the layer of un-cured SU8 monomer to a suitable degree;
soft baking at least a portion of the layer of SU8 of the second substrate;
exposing at least the portion of the layer of SU8 of the second substrate to ultraviolet (UV) radiation to cross-link at least the portion of the layer of SU8 of the second substrate;
compressing the layer of partially cross-linked SU8 polymer on the layer of SU8 of the first substrate against the cross-linked portion of the layer of SU8 of the second substrate at a suitable starting temperature (Tₛ) for a suitable time period (t_{comp}); and
elevating the temperature during compression from Tₛ to a suitable elevated temperature (Tₑ), thereby bonding the first and second substrates.

4. The method according to claim 1, wherein the first substrate is a major substrate.

5. The method according to claim 1, wherein the second substrate is a handling wafer.

6. The method according to claim 1, wherein the second substrate is a major substrate.

7. The method according to claim 1, further comprising:
exposing the cross-linked portion of the layer of SU8 of the second substrate to oxygen plasma before compressing the cross-linked portion of the layer of SU8 of the first substrate or the layer of partially cross-linked SU8 polymer on the layer of SU8 of the first substrate against the cross-linked portion of the layer of SU8 of the second substrate.

8. The method according to claim 1, further comprising:
arranging a temperature sensitive substrate or biomolecules on the first substrate or on the second substrate.

9. The method according to claim 1, wherein cross-linking at least the portion of the layer of SU8 of the first substrate to a suitable degree comprises subjecting said portion of the layer of SU8 of the first substrate to a suitable cross-linking temperature (T_{pc}) for a suitable period of time (t_{pc}).

10. The method according to claim 2, wherein cross-linking the layer of un-cured SU8 monomer on the layer of SU8 of the first substrate to a suitable degree comprises subjecting the layer of un-cured SU8 monomer on the layer of SU8 of the first substrate to a suitable cross-linking temperature (T_{pc}) for a suitable period of time (t_{pc}).

11. The method according to claim 1, wherein cross-linking at least a portion of the layer of SU8 of the second substrate to a suitable degree comprises subjecting said portion of the layer of SU8 of the second substrate to a suitable cross-linking temperature (T_{pc}) for a suitable period of time (t_{pc}).

12. The method according to claim 9, wherein T_{pc} is a temperature between about room temperature to about 50 degree Celsius (° C.).

13. The method according to claim 9, wherein t_{pc} for cross-linking at least the portion of the layer of SU8 of the first substrate or cross-linking the layer of un-cured SU8 monomer on the layer of SU8 of the first substrate to a suitable degree is between about thirty minutes to about sixty minutes or about thirty minutes to about 1 week.

14. The method according to claim 11, wherein t_{pc} for cross-linking at least a portion of the layer of SU8 of the second substrate to a suitable degree is between about 1 minute to about 1 week.

15. The method according to claim 9, wherein compression starts at Tₛ, which is lower than or equal to T_{pc}.

16. The method according to claim 1, wherein Tₛ is about room temperature to 50 degree Celsius (° C.) and Tₑ is less than or equal to about 90 degree Celsius (° C.).

17. The method according to claim 1, wherein (t_{comp}) is between about thirty minutes to about forty-eight hours.

18. The method according to claim 1, wherein elevating the temperature from Tₛ to Tₑ during compression is carried out linearly, exponentially, step-wise or any combination thereof.

19. The method according to claim 1 wherein the temperature at which compression is carried out is inversely related to the time period during which said compression is carried out.

20. The method according to claim 1, wherein the suitable degree of cross-linking of the portion of the layer of SU8 of the first substrate or cross-linking the layer of un-cured SU8 monomer on the layer of SU8 of the first substrate is ascertained when said cross-linked portion of the layer of SU8 of the first substrate or the layer of partially cross-linked SU8 polymer on the layer of SU8 of the first substrate dissolves in acetone.

21. The method according to claim 1, wherein the suitable degree of cross-linking of the portion of the layer of SU8 of the first substrate or cross-linking the layer of un-cured SU8 monomer on the layer of SU8 of the first substrate is ascertained when said cross-linked portion of the layer of SU8 of the first substrate or the layer of partially cross-linked SU8 polymer on the layer of SU8 of the first substrate remains undissolved in isopropanol.

22. The method according to claim 1, wherein the suitable degree of cross-linking of the portion of the layer of SU8 of the second substrate is ascertained when said cross-linked portion of the layer of SU8 dissolves in acetone.
